(19) United States
(12) Patent Application Publication
(10) Pub. No.: US 2009/0144606 A1
(43) Pub. Date: Jun. 4, 2009

(54) System and method for performing filtering operations on a hierarchical table

(75) Inventor: Peter Vignet, San Francisco, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SAP AG

(21) Appl. No.: 11/998,591

(22) Filed: Nov. 29, 2007

(51) Int. Cl. G06F 17/00; G06F 7/06; G06F 3/048; G06F 17/30

(52) U.S. Cl. 715/227; 707/5; 715/810; 707/E17.059; 707/E17.016

(57) ABSTRACT

A system and method are described selectively filtering certain rows of a table. For example, a computer-implemented method according to one embodiment of the invention comprises: receiving user-specified filtering criteria from a client indicating one or more rows of a table to be included within a filtering operation; receiving filtering data comprising a value or range of values for filtering the one or more rows to be included within the filtering operation; filtering the one or more rows indicated by the user-specified filtering criteria using the filtering data to generate a set of filtered rows; and generating a table containing the filtered rows and other rows to which filtering was not applied.

### BACKGROUND

1. Field of the Invention

This invention relates generally to the field of data processing systems. More particularly, the invention relates to a system and method for performing filtering operations on a hierarchical table.

2. Description of the Related Art

### Multi-Tiered Enterprise Computing Systems

Traditional client-server systems employed a two-tiered architecture such as that illustrated in FIG. 1a. Applications 102 executed on the client side 100 of the two-tiered architecture are comprised of a monolithic set of program code including a graphical user interface component, presentation logic, business logic and a network interface that enables the client 100 to communicate over a network 103 with one or more servers 101. A database 104 maintained on the server 101 provides non-volatile or “persistent” storage for the data accessed and/or processed by the application 102.

The “business logic” component of the application represents the core program code of the application, i.e., the rules governing the underlying business process (or other functionality) provided by the application. The “presentation logic” describes the specific manner in which the results of the business logic are formatted for display on the user interface. The “database” 104 includes data access logic used by the business logic to store and retrieve data.

The limitations of the two-tiered architecture illustrated in FIG. 1a become apparent when employed within a large enterprise. For example, installing and maintaining up-to-date client-side applications on a large number of different clients is a difficult task, even with the aid of automated administration tools. Moreover, a tight coupling of business logic, presentation logic and the user interface logic makes the client-side code very brittle. Changing the client-side user interface of such applications is extremely hard without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed, as illustrated in FIG. 1b. In the multi-tiered system, the presentation logic 121, business logic 122 and database 123 are logically separated from the user interface 120 of the application. These layers are moved off of the client 125 to one or more dedicated servers on the network 103. For example, the presentation logic 121, the business logic 122, and the database 123 may each be maintained on separate servers, 126, 127 and 128, respectively.

This separation of logical components and the user interface provides a more flexible and scalable architecture compared to that provided by the two-tier model. For example, the separation ensures that all clients 125 share a single implementation of business logic 122. If business rules change, changing the current implementation of business logic 122 to a new version may not require updating any client-side program code. In addition, presentation logic 121 may be provided which generates code for a variety of different user interfaces 120, which may be standard browsers such as Internet Explorer® or Netscape Navigator®.

The multi-tiered architecture illustrated in FIG. 1b may be implemented using a variety of different application technologies at each of the layers of the multi-tier architecture, including those based on the Java 2 Enterprise Edition™ (“J2EE”) standard, the Microsoft .NET standard and/or the Advanced Business Application Programming (“ABAP”) standard developed by SAP AG. For example, as described below, in a J2EE environment, the business layer 122, which handles the core business logic of the application, is comprised of Enterprise Java Bean (“EJB”) components with support for EJB containers. Within a J2EE environment, the presentation layer 121 is responsible for generating servlets and Java Server Pages (“JSP”) interpretable by different types of browsers at the user interface layer 120.

### J2EE Application Server Architecture

FIG. 1c illustrates a typical J2EE application server 200 in which the presentation layer is implemented by a “Web container” 211 and the business layer is implemented by an Enterprise Java Bean (“EJB”) container 201. Containers are runtime environments which provide standard common services 219, 209 to runtime components. For example, the Java Naming and Directory Interface (“JNDI”) is a service that provides application components with methods for performing standard naming and directory services. Containers also provide unified access to enterprise information systems 217 such as relational databases through the Java Database Connectivity (“JDBC”) service, and legacy computer systems through the J2EE Connector Architecture (“JCA”) service. In addition, containers provide a declarative mechanism for configuring application components at deployment time through the use of deployment descriptors.

As illustrated in FIG. 1c, each layer of the J2EE architecture includes multiple containers. The Web container 211, for example, is itself comprised of a servlet container 215 for processing servlets and a Java Server Pages (“JSP”) container 216 for processing Java server pages. The EJB container 201 includes three different containers for supporting three different types of enterprise Java beans: a session bean container 205 for session beans, a entity bean container 206 for entity beans, and a message driven bean container 207 for message driven beans. A more detailed description of J2EE containers and J2EE services can be found in RAGAE GHALY AND KRISHNA KOTHAPALLI, SAMS TEACH YOURSELF EJB IN 21 DAYS (2003) (see, e.g., pages 353-376).

### SUMMARY

A system and method are described selectively filtering certain rows of a table. For example, a computer-implemented method according to one embodiment of the invention comprises: receiving user-specified filtering criteria from a client indicating one or more rows of a table to be included within a filtering operation; receiving filtering data comprising a value or range of values for filtering the one or more rows to be included within the filtering operation; filtering the one or more rows indicated by the user-specified filtering criteria using the filtering data to generate a set of filtered rows; and generating a table containing the filtered rows and other rows to which filtering was not applied.

### BRIEF DESCRIPTION OF THE DRAWINGS

A better understanding of the present invention can be obtained from the following detailed description in conjunction with the following drawings, in which:

FIG. 1a illustrates a traditional two-tier client-server architecture.

FIG. 1b illustrates a prior art multi-tier client-server architecture.

FIG. 1c illustrates a multi-tiered application server architecture according to the Java 2 Enterprise Edition (“J2EE”) standard.

FIG. 2 illustrates a model view controller (“MVC”) architecture implemented in accordance with one embodiment of the invention.

FIG. 3 illustrates a filtering operation within an exemplary table.

FIG. 4 illustrates an exemplary hierarchical table.

FIG. 5 illustrates an exemplary pseudo-hierarchical table.

FIG. 6 illustrates an exemplary pseudo-hierarchical table which is used to provide a price to a parent (master) row.

FIG. 6 illustrates an exemplary pseudo-hierarchical table which is used to provide a price to a parent (master) row.

FIG. 7 illustrates an exemplary pseudo-hierarchical table in which a filtering operation has been performed.

FIG. 8 illustrates an exemplary pseudo-hierarchical table with specific values set in its master rows.

FIG. 9 illustrates an exemplary pseudo-hierarchical table in which a column has been filtered with a specific value.

FIG. 10 illustrates a model-view-controller architecture employed in one embodiment of the invention.

FIG. 11 illustrates a graphical user interface for selecting filtering rows according to one embodiment of the invention.

FIG. 12 illustrates an exemplary table filtered by one embodiment of the invention.

FIG. 13 illustrates another exemplary table filtered by one embodiment of the invention.

FIG. 14 illustrates a high-level system architecture on which embodiments of the invention may be implemented.

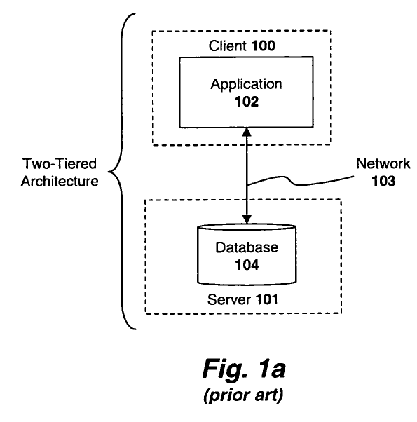

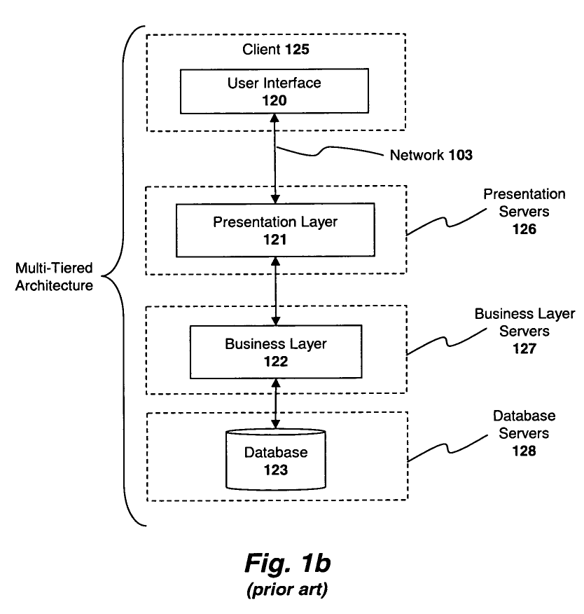

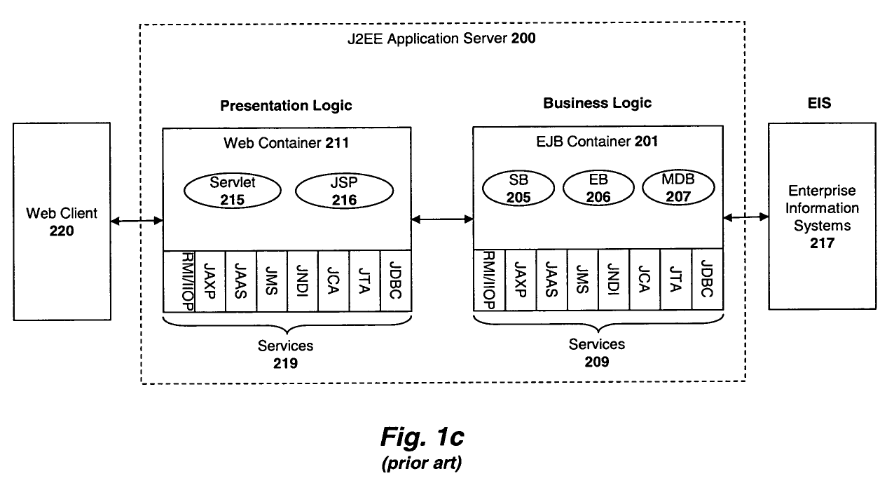

### DETAILED DESCRIPTION OF PREFERRED EMBODIMENTS

Described below is a system and method for performing selective filtering operations on hierarchical tables. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

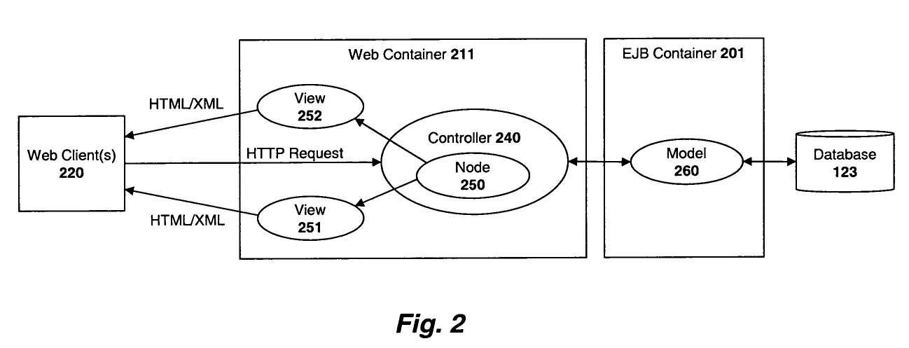

The display of data records in tables and forms, and the associated editing of the tables and forms (e.g., selecting, deleting, sorting, etc) by clients are central functions in Web-based applications. Thus, various techniques are provided within the J2EE architecture for creating and working with tables in response to client requests. In particular, under a model-view-controller (“MVC”) architecture, illustrated in FIG. 2, Web-based content using tables may be created within the Web Container 211 using “controllers” 240 and “views” 251-252 that operate in conjunction with “models” 260 within the EJB container 201. A detailed description of the MVC architecture is beyond the scope of the present application but, briefly, the controller 240 manages the underlying table structure and data, referred to in FIG. 2 as a context node 250. The table structure is presented to Web clients 220 in the form of one or more “views” 251-252 which indicate, for example, how the table is presented within a Web page. Controllers may be implemented by servlets and views by Java server pages. The model 260 within the EJB container 201 provides an interface between the controller 240 and the underlying table data stored within the database 123. See, e.g., GHALY and KOTHAPALLI mentioned above for additional detail on the MVC architecture at pages 148-152.

A node 250 may be filtered and/or otherwise modified in response to requests from Web clients. For example, as part of a search request a Web client may designate a filtering operation such as “only display client records in the table beginning with the letters DE” or “only display client records with a value of 1000.” As a result the table node will be filtered and the results provided to the client in the form of a filtered table.

Various existing application server platforms employ a Model View Controller architecture to generate views for requesting clients. For example, “Web Dynpro” is a programming paradigm developed by SAP AG (the assignee of the present application) which implements a Model View Controller architecture for generating and displaying views (e.g., tables) to end users. While certain embodiments of the invention are described herein within the context of Web Dynpro, it should be noted that the underlying principles of the invention are not limited to any particular programming paradigm.

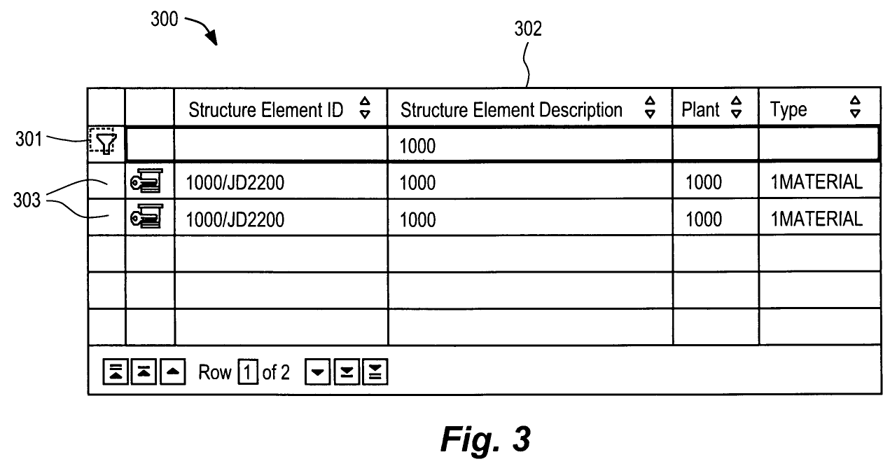

As illustrated in FIG. 3, a Web Dynpro table 300 represents a two-dimensional data set arranged in rows 301, 303 and columns 302. The table 302 represents data from the view context and receives its data from a multi-element context node, represented by node 250 in FIG. 2. At runtime, each element of the multi-element context node is represented as a table row. The number of table rows is therefore equal to the number of node elements. The table columns correspond to the node attributes.

The controller 240 within the Model View Controller architecture implements a table filter which filters table rows based on user-specified filtering criteria. In the exemplary table 300 shown in FIG. 3, the filtering row is the first row 301. In the illustrated example, the column labeled “Structure Element Description” has been filtered for a value of 1000 and the filter has been applied to all rows of the table, resulting in two rows 303 being displayed which correspond to the value of 1000.

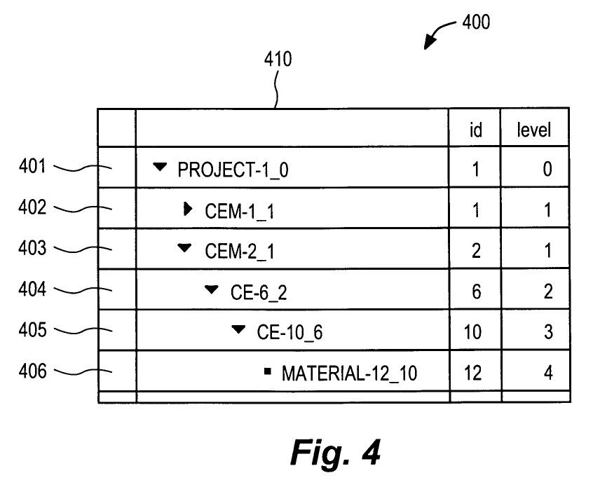

In a hierarchical table, the rows are presented in a specific order to indicate parent-child relationships. FIG. 4 illustrates an exemplary hieratical table 400 in which row 401 is a parent to rows 402-403; row 403 is a parent to row 404; row 404 is a parent to row 405; and row 405 is a parent to row 406. As illustrated in the figure, the position and graphical features associated with each element within a particular column 410 identify the position that the element occupies within the hierarchy.

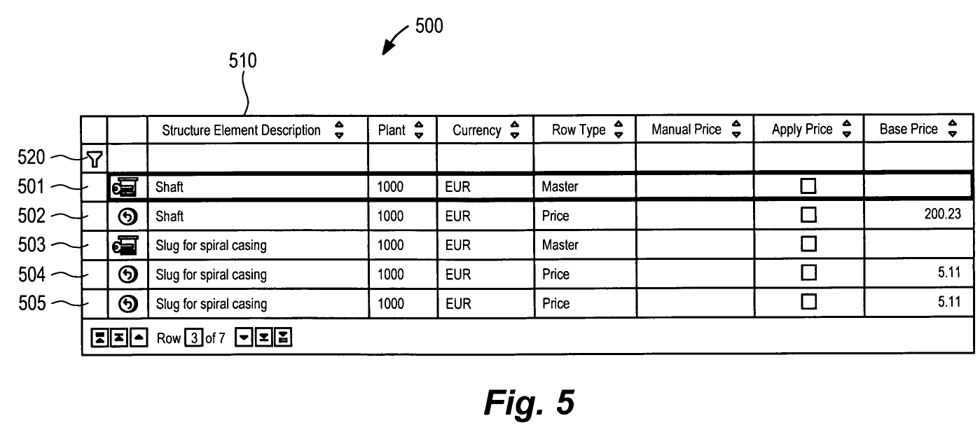

A flat table such as the one illustrated in FIG. 3 may need to simulate a hierarchical table in some situations. When a flat table simulates a hierarchy, the table is sometimes called a “pseudo hierarchical” table—i.e., a flat table that usually has successive repeated values in it first columns. In the exemplary table 500 illustrated in FIG. 5, the first two rows 501-502 have repeated values within the first column 510. They form a pseudo hierarchy since the first row 501 is of type Master and the next row 502 is of type Price. The first row is the parent and the second row is the child. Similarly, the third through fifth rows 503-505 have repeated values within the first column 510. The third row 503 is of type Master and the next two rows 504-505 are of type Price. Thus, the third row 503 is a master row that has two child price rows 504-505.

Thus, a flat table can represent a pseudo hierarchy by maintaining its rows in a parent-children sequence. In addition, a filter may be used to filter all rows according values entered into column filters, located in FIG. 5 within filter row 520 just under the column header. Moreover, a row may be defined as a particular type, such as a hierarchical type. For a simple two-level hierarchy, a row can be defined as a “parent” type or “child” type. If the hierarchy is deeper, various additional type levels may be defined (e.g., child level 1, child level 2, etc). For the sake of clarity, the embodiments of the invention are described herein within the context of a two-level hierarchy. However, the underlying principles of the invention may be implemented using virtually any number of row types.

One problem which currently exists is that, when it comes to filtering, the user may want to filter a column for a value existing only on certain types of rows such as parent rows only, or on child rows only, or on both types of rows. For example a user may need to filter only the parent type rows for a specific value but wants the child type row to remain unfiltered.

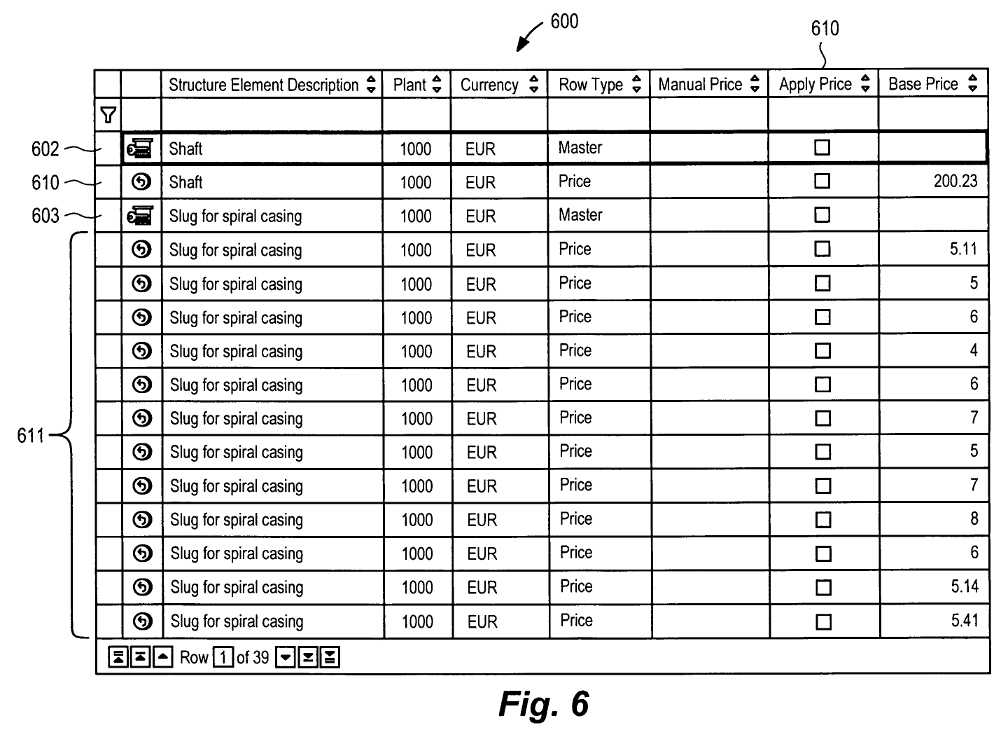

This can be illustrated with an example. FIG. 6 illustrates a pseudo hierarchical table 600 which is used to provide a price to a material of a master row 602, 603 according to the proposal of the price rows 610, 611 under it. By clicking a check box within column 601 of one of the price rows 610, 611, the proposed price is applied to the material master row 602, 603 above it.

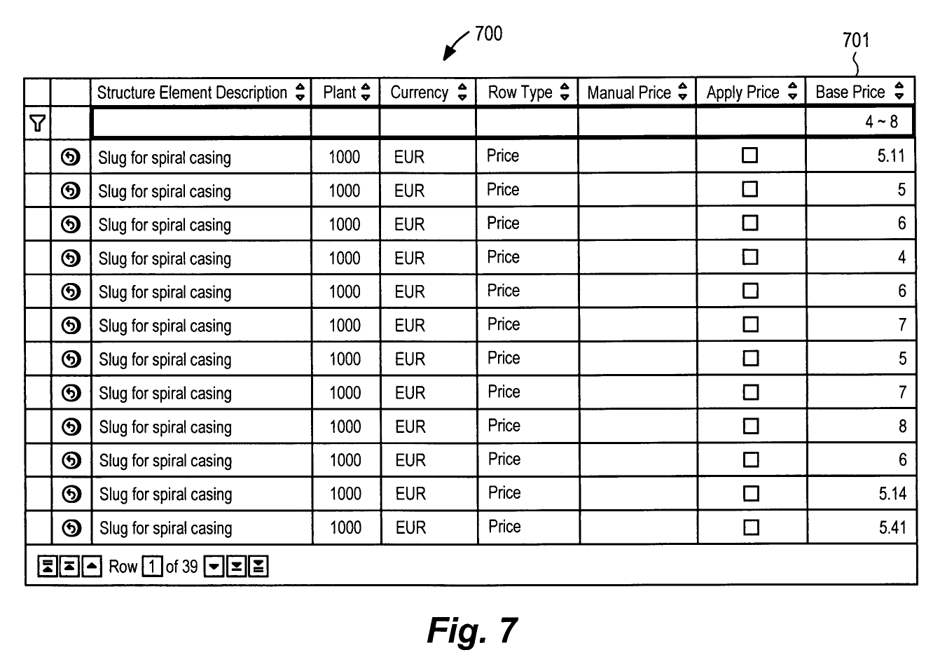

If there are a significant number of price rows for one master row, the user may wish to filter the price rows for a certain price or price range. Assuming the user filters for a value between 4 and 8 within column 701, the filtered table 700 will look as illustrated in FIG. 7. Note that all the rows have been filtered for this price range including the master rows 602, 603. In this case, the master rows 602, 603 have been eliminated since they do not meet the required filter criterion. In other words, the user was looking for a price for a master row that has been filtered out. The user may have found the price he was looking for, but he lost the master row, so he cannot apply the price to the master row he was working on.

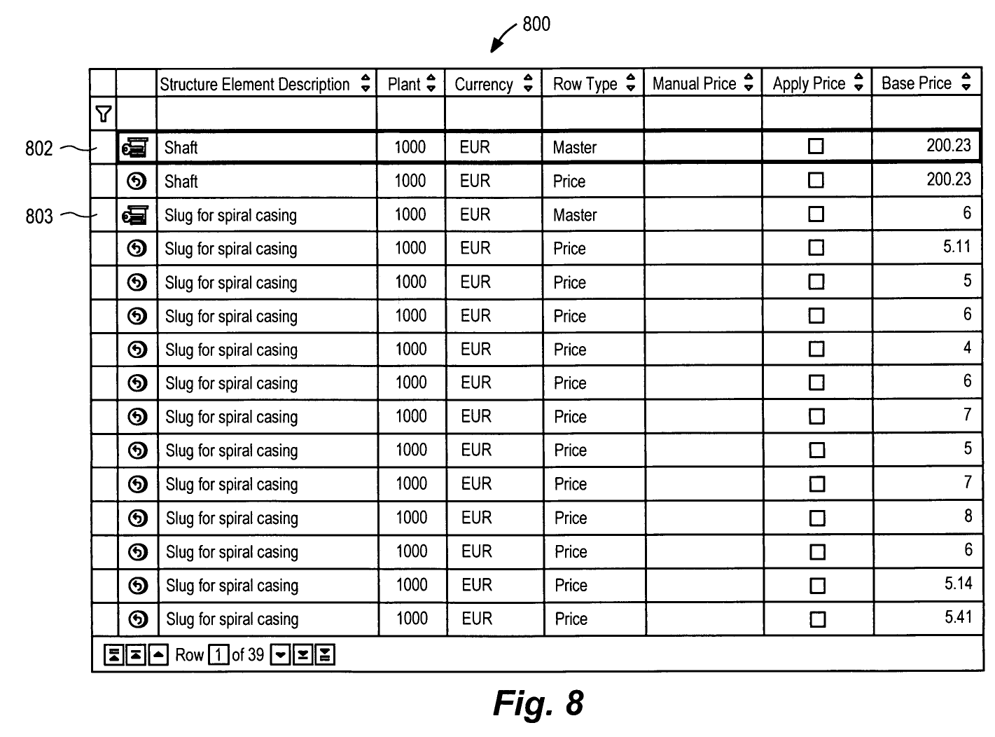

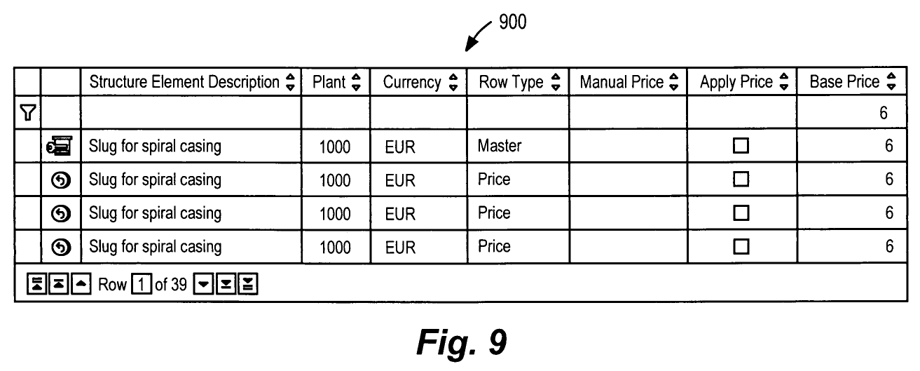

Continuing with the foregoing example, assume that the user has priced all the master rows 802, 803 as illustrated in FIG. 8. Now the user wants to review his work to be sure that he gave the best prices for each master row 802, 803. He filters the master row for a price of 6 resulting in a table 900 such as the one illustrated in FIG. 9. He found the master row for price 6 and all price rows with price 6, but lost all price rows that have a price lower or greater than 6. Consequently, he cannot be sure that he gave the best price for this master row. What he really wants is only the master rows to be filtered with a price of 6 (with the child rows remaining unfiltered).

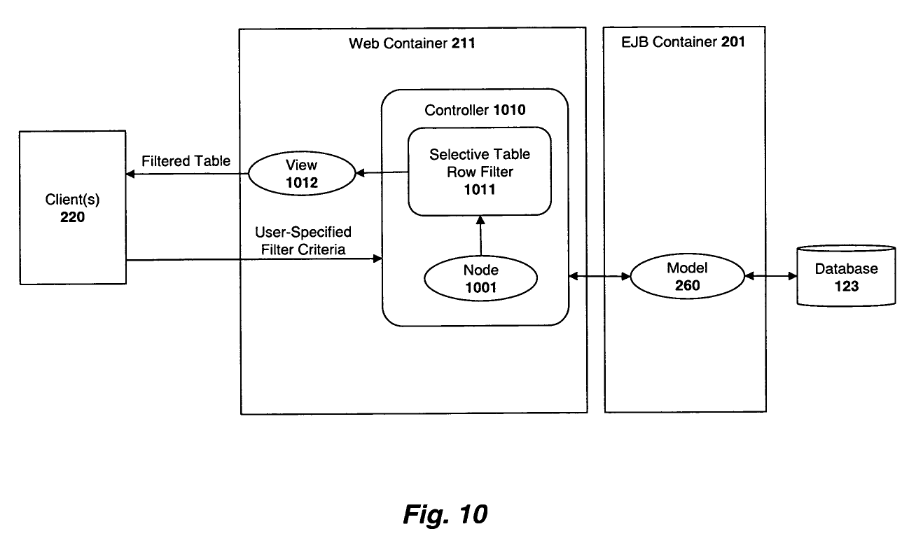

One embodiment of the invention solves these problems by applying a selective table row filter to filter only certain user-specified rows of a table. An architecture according to this embodiment of the invention is illustrated in FIG. 10 which shows a controller 1010 within a model view controller architecture generating a table view 1012 in response to user requests. Specifically, the controller 1010 includes a selective table row filter 1011 for filtering table data within a node 1001 (e.g., a multi-element context node) in response to user-specified filter criteria. In one embodiment, the user specifies one or more row types which are to be included in the filter request. For example, the user may specify that filtering is applied only to master rows or child rows within the table. In one embodiment, for tables containing a hierarchy of more than two levels, the user may specify rows above or below a certain level in the hierarchy. Various additional filtering criteria may be implemented by the selective table row filter 1011 while still complying with the underlying principles of the invention.

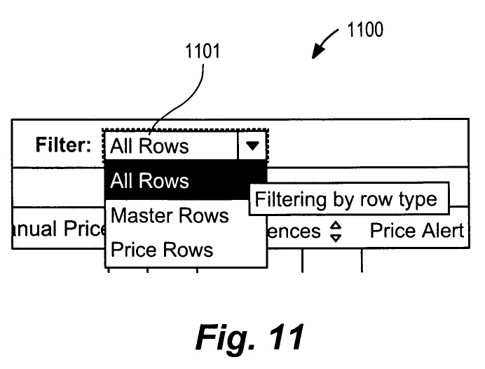

One embodiment of a graphical user interface 1100 allowing a user to specify rows types for filtering is illustrated in FIG. 11. The graphical user interface includes a drop down menu 1101 containing a plurality of options for filtering according a row type. For a pseudo hierarchical table with a simple two-level hierarchy, the row types may be “Parent” and “Child.” For a more complex hierarchy, the level of the hierarchy could be introduced in the definition of hierarchical types.

Returning to the illustrated example, a row has one of the two possible types: either a “Master” type or a “Price” type. To apply a filter to a selected row type, the user selects from the drop-down menu 1101 the option to filter only the row of type “master,” the row of type “price,” or all rows regardless of type.

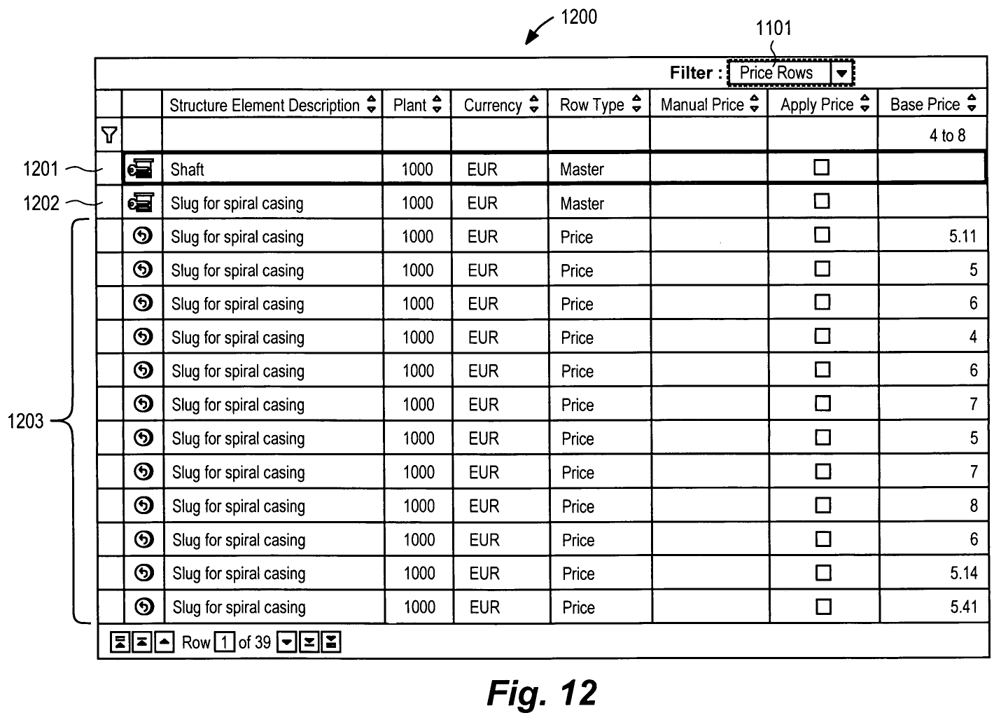

Recall the problems described above. Now the selective table row filter 1011 will filter the table based on the needs of the user. In the first case, the end user wanted to filter the price rows only for a value and not the master rows. Selecting “Price Rows” from the drop down menu 1101 produced the desired result within table 1200 illustrated in FIG. 12. In this case, the selective table row filter 1011 filters the price rows 1203 only and passes through the master rows 1201, 1202. The end user may now view the relevant master row and have a price applied to it.

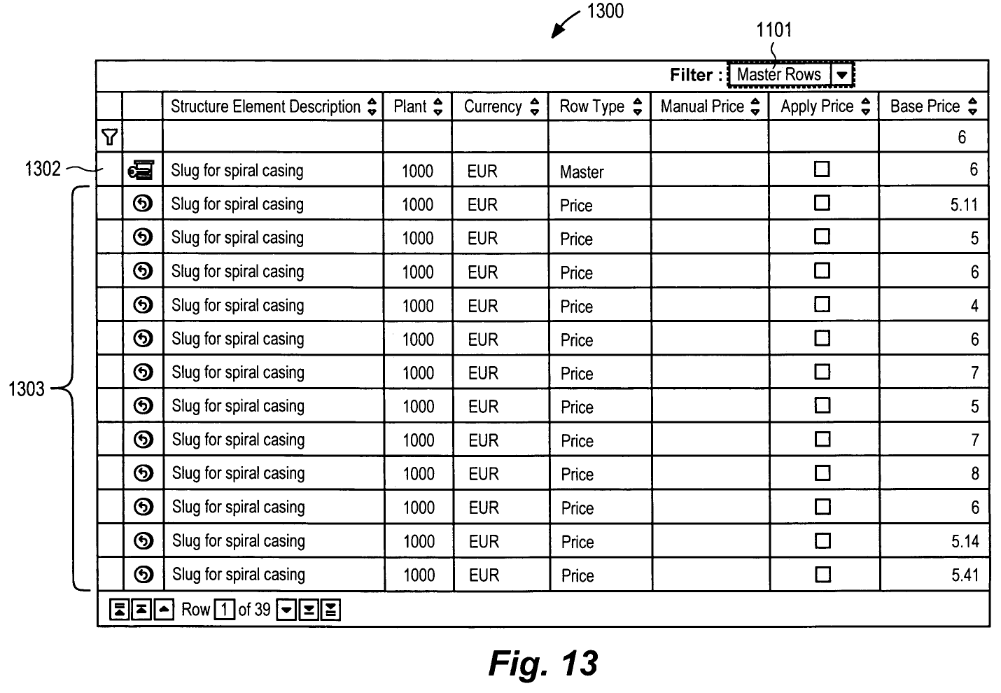

In the second case the user wanted to review a price for master rows having a price of 6, but wanted to filter only the master rows and not the price rows. Selecting “Master Rows” from the drop-down menu 1101 and applying the filter as illustrated in FIG. 13 results in only the master row 1302 with a price of 6 being displayed. In this case, none of the price rows 1303 have been filtered.

In other words, the selective table row filter described above filters only the rows that have a user-specified row type. The selective row filter is particularly useful when working with pseudo hierarchical tables—i.e., flat tables that represent a hierarchy. In one embodiment, the Selective Table Row Table Filter is implemented as a Java Class that may be used by any application.

In one embodiment, the same drop-down menu 1101 illustrated in FIG. 11 or a separate drop-down menu (not shown) provides the user with a list of attributes which are not displayed as columns in the table 1100. The user may select an attribute from the list to filter the table based on that attribute. Various other types of user interface elements may be provided allowing the user to select an attribute which is not displayed as a column within the table 1100.

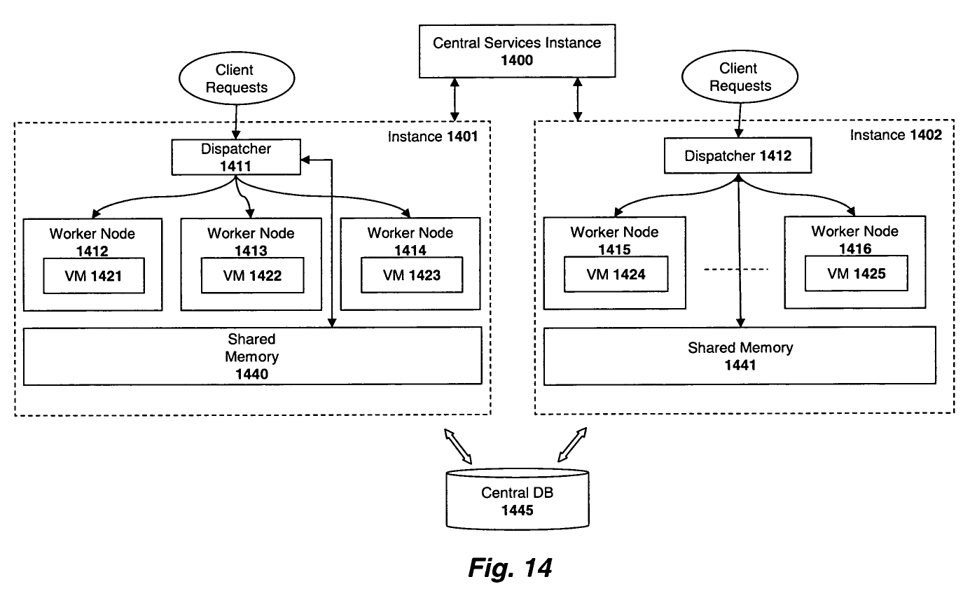

A system architecture on which embodiments of the invention may be implemented is illustrated in FIG. 14. The architecture includes a plurality of application server “instances” 1401 and 1402. The application server instances 1401 and 1402 each include a group of worker nodes 1412-1414 and 1415-1416 (also sometimes referred to herein as “server nodes”), respectively, and a dispatcher 1411 and 1412, respectively. The application server instances 1401, 1402 communicate through a central services instance 1400 using message passing. In one embodiment, the central services instance 1400 includes a locking service and a messaging service (described below). The combination of all of the application server instances 1401 and 1402 and the central services instance 1400 is referred to herein as a “cluster.” Although the following description will focus solely on instance 1401 for the purpose of explanation, the same principles apply to other instances within the cluster.

The worker/server nodes 1412-1414 within instance 1401 provide the business and presentation logic for the network applications supported by the system including, for example, the model-video controller architecture described herein. Each of the worker nodes 1412-1414 within a particular instance may be configured with a redundant set of programming logic and associated data, represented as virtual machines 1421-1423 in FIG. 14. In one embodiment, the dispatcher 1411 distributes service requests from clients to one or more of the worker nodes 1412-1414 based on the load on each of the servers. For example, in one embodiment, the dispatcher maintains separate queues for each of the 1412-1414 in a shared memory 1440. The dispatcher 1411 fills the queues with client requests and the worker nodes 1412-1414 consume the requests from each of their respective queues. The client requests may be from external clients (e.g., browser requests) or from other components/objects within the instance 1401 or cluster.

In one embodiment, the worker nodes 1412-1414 may be Java 2 Enterprise Edition (“J2EE”) worker nodes which support Enterprise Java Bean (“EJB”) components and EJB containers (at the business layer) and Servlets and Java Server Pages (“JSP”) (at the presentation layer). In one embodiment, JSPs are used to implement the different views 1012 described above, and servlets are used to implement the controllers 1010. In this embodiment, the virtual machines 1421-1425 implement the J2EE standard (as well as the additional non-standard features described herein). It should be noted, however, that certain high-level features described herein may be implemented in the context of different software platforms including, by way of example, Microsoft .NET platforms and/or the Advanced Business Application Programming (“ABAP”) platforms developed by SAP AG, the assignee of the present application.

In one embodiment, communication and synchronization between each of the instances 1401, 1402 is enabled via the central services instance 1400. As mentioned above, the central services instance 1400 includes a messaging service and a locking service. The message service allows each of the servers within each of the instances to communicate with one another via a message passing protocol. For example, messages from one server may be broadcast to all other servers within the cluster via the messaging service (e.g., such as the cache configuration messages described below). Alternatively, messages may be addressed directly to specific servers within the cluster (i.e., rather than being broadcast to all servers). In one embodiment, the locking service disables access to (i.e., locks) certain specified portions of configuration data and/or program code stored within a central database 1445. The locking service locks data on behalf of various system components which need to synchronize access to specific types of data and program code. In one embodiment, the central services instance 1400 is the same central services instance as implemented within the Web Application Server version 6.3 and/or 6.4 developed by SAP AG. However, the underlying principles of the invention are not limited to any particular type of central services instance.

In addition, unlike prior systems, one embodiment of the invention shares objects across virtual machines 1421-1425. Specifically, in one embodiment, objects such as session objects which are identified as “shareable” are stored within a shared memory region 1440, 1441 and are made accessible to multiple virtual machines 1421-1425. Creating new object instances from scratch in response to client requests can be a costly process, consuming processing power and network bandwidth. As such, sharing objects between virtual machines as described herein improves the overall response time of the system and reduces server load.

In a shared memory implementation, a shared memory area 1440, 1441 or “heap” is used to store data objects that can be accessed by multiple virtual machines 1421-1425. The data objects in a shared memory heap should generally not have any pointers or references into any private heap (e.g., the private memory regions/heaps of the individual virtual machines). This is because if an object in the shared memory heap had a member variable with a reference to a private object in one particular virtual machine, that reference would be invalid for all the other virtual machines that use that shared object.

More formally, this restriction can be thought of as follows: For every shared object, the transitive closure of the objects referenced by the initial object should only contain shared objects at all times. Accordingly, in one implementation of the invention, objects are not put into the shared memory heap by themselves—rather, objects (such as the session objects described herein) are put into the shared memory heap in groups known as “shared closures.” A shared closure is an initial object plus the transitive closure of all the objects referenced by the initial object.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although many of the embodiments set forth above relate to a Web Dynpro, Java or J2EE implementation, the underlying principles of the invention may be implemented in virtually any client-server environment. Moreover, although some of the embodiments set forth above are implemented within a shared memory environment, the underlying principles of the invention are equally applicable to a non-shared memory environment. Finally, it should be noted that the terms “client” and “server” are used broadly to refer to any applications, components or objects which interact over a network.

Accordingly, the scope and spirit of the invention should be judged in terms of the claims which follow.

What is claimed is:

1. A computer-implemented method comprising:
receiving user-specified filtering criteria from a client indicating one or more rows of a table to be included within a filtering operation;
receiving filtering data comprising a value or range of values for filtering the one or more rows to be included within the filtering operation;
filtering the one or more rows indicated by the user-specified filtering criteria using the filtering data to generate a set of filtered rows; and
generating a table containing the filtered rows and other rows to which filtering was not applied.

2. The method as in claim 1 further comprising:
rendering the table containing the filtered rows at the client.

3. The method as in claim 1 wherein at least one of the rows to be filtered comprises a parent row to a plurality of child rows and wherein the child rows are not included within the rows to be filtered.

4. The method as in claim 1 wherein the rows to be filtered comprise child rows to at least one parent row and wherein the parent row is not included within the rows to be filtered.

5. The method as in claim 1 wherein the table comprises a pseudo-hierarchical table.

6. The method as in claim 1 further comprising:
generating a selection menu on the client, the selection menu providing options for selecting rows to be included within the filtering operation; and
generating the user-specified filtering criteria in response to a selection of one of more of the options within the selection menu.

7. The method as in claim 1 further comprising:
generating a filtering row on the client, the filtering row having data entry fields within one or more columns of the table, the data entry fields for entering the filtering data comprising a value or range of values for filtering the one or more rows to be included within the filtering operation.

8. A system comprising a memory for storing program code and a processor for processing the program code to perform the operations of:
receiving user-specified filtering criteria from a client indicating one or more rows of a table to be included within a filtering operation;
receiving filtering data comprising a value or range of values for filtering the one or more rows to be included within the filtering operation;
filtering the one or more rows indicated by the user-specified filtering criteria using the filtering data to generate a set of filtered rows; and
generating a table containing the filtered rows and other rows to which filtering was not applied.

9. The system as in claim 8 comprising additional program code which causes the processor to perform the operations of:
rendering the table containing the filtered rows at the client.

10. The system as in claim 8 wherein at least one of the rows to be filtered comprises a parent row to a plurality of child rows and wherein the child rows are not included within the rows to be filtered.

11. The system as in claim 8 wherein the rows to be filtered comprise child rows to at least one parent row and wherein the parent row is not included within the rows to be filtered.

12. The system as in claim 8 wherein the table comprises a pseudo-hierarchical table.

13. The system as in claim 8 comprising additional program code which causes the processor to perform the operations of:
generating a selection menu on the client, the selection menu providing options for selecting rows to be included within the filtering operation; and
generating the user-specified filtering criteria in response to a selection of one of more of the options within the selection menu.

14. The system as in claim 8 comprising additional program code which causes the processor to perform the operations of:
generating a filtering row on the client, the filtering row having data entry fields within one or more columns of the table, the data entry fields for entering the filtering data comprising a value or range of values for filtering the one or more rows to be included within the filtering operation.

15. A machine-readable medium having program code stored thereon which, when execute by a machine, causes the machine to perform the operations of:
receiving user-specified filtering criteria from a client indicating one or more rows of a table to be included within a filtering operation;
receiving filtering data comprising a value or range of values for filtering the one or more rows to be included within the filtering operation;
filtering the one or more rows indicated by the user-specified filtering criteria using the filtering data to generate a set of filtered rows; and
generating a table containing the filtered rows and other rows to which filtering was not applied.

16. The machine-readable medium as in claim 15 comprising additional program code which causes the machine to perform the operations of:
rendering the table containing the filtered rows at the client.

17. The machine-readable medium as in claim 15 wherein at least one of the rows to be filtered comprises a parent row to a plurality of child rows and wherein the child rows are not included within the rows to be filtered.

18. The machine-readable medium as in claim 15 wherein the rows to be filtered comprise child rows to at least one parent row and wherein the parent row is not included within the rows to be filtered.

19. The machine-readable medium as in claim 15 wherein the table comprises a pseudo-hierarchical table.

20. The machine-readable medium as in claim 15 comprising additional program code which causes the machine to perform the operations of:
generating a selection menu on the client, the selection menu providing options for selecting rows to be included within the filtering operation; and
generating the user-specified filtering criteria in response to a selection of one of more of the options within the selection menu.

21. The machine-readable medium as in claim 15 comprising additional program code which causes the machine to perform the operations of:
generating a filtering row on the client, the filtering row having data entry fields within one or more columns of the table, the data entry fields for entering the filtering data comprising a value or range of values for filtering the one or more rows to be included within the filtering operation
